(19) United States
(12) Patent Application Publication
(10) Pub. No.: US 2016/0223927 A1
(43) Pub. Date: Aug. 4, 2016

(54) POLYESTER RESIN COMPOSITION FOR ELECTROPHOTOGRAPHIC TONER, AND ELECTROPHOTOGRAPHIC TONER

(71) Applicant: DIC CORPORATION, Tokyo (JP)

(72) Inventors: Hirotake Fukuoka, Ichihara-shi (JP); Hiroyuki Mariko, Ichihara-shi (JP)

(21) Appl. No.: 15/021,786

(22) PCT Filed: Sep. 11, 2014
(86) PCT No.: PCT/JP2014/074111

§ 371 Date: Mar. 14, 2016

(30) Foreign Application Priority Data
Sep. 25, 2013 (JP) 2013-198275

(51) Int. Cl. G03G 9/087; C08G 63/672

(52) U.S. Cl. CPC G03G 9/08755; C08G 63/672

(57) ABSTRACT

Provided are a polyester resin composition from which an electrophotographic toner having excellent charge amount, excellent electrostatic stability, excellent low-temperature fixing property, and excellent resistance to offset can be obtained, and an electrophotographic toner containing the polyester resin composition. Specifically, provided are a polyester resin composition for an electrophotographic toner, containing a polyester resin (A) which is obtained by reacting a monobasic acid (a1), a polybasic acid (a2), a polyhydric alcohol (a3), a monoepoxy compound (a4), and a polyepoxy compound (a5) having four or more epoxy groups, and an electrophotographic toner containing the polyester resin composition for an electrophotographic toner.

### TECHNICAL FIELD

The present invention relates to a polyester resin composition from which an electrophotographic toner having excellent charge amount, excellent electrostatic stability, excellent low-temperature fixing property, and excellent resistance to offset can be obtained, and an electrophotographic toner containing the polyester resin composition.

### BACKGROUND ART

In an electrophotographic method, there are a number of development methods and, for example, a single-component development method and a two-component development method have been known. As an electrophotographic toner having excellent electrostatic property and electrostatic stability used in the electrophotographic method, for example, an electrophotographic toner using a polyester resin using a combination of a polybasic acid, a polyhydric alcohol, and a plurality of epoxy compounds having different numbers of epoxy groups contained has been known (see, for example, PTLs 1 and 2).

However, the electrophotographic toners disclosed in the PTLs 1 and 2 cannot achieve excellent balance between the low-temperature fixing property, the resistance to offset, the electrostatic property, and the electrostatic stability. Particularly, recently, an electrophotographic toner is demanded to have a fixing property at lower temperatures, and the above toners cannot satisfactorily meet such a demand.

### CITATION LIST

### Patent Literature

[PTL 1] JP-A-2000-242043

[PTL 2] JP-A-2009-265580

### SUMMARY OF INVENTION

### Technical Problem

In view of the above, an object of the present invention is to provide a polyester resin composition from which an electrophotographic toner having excellent fixing property at lower temperatures, excellent resistance to offset, excellent charge amount, and excellent electrostatic stability can be obtained, and an electrophotographic toner containing the polyester resin composition.

### Solution to Problem

The present inventors have conducted extensive and intensive studies. As a result, it has been found that the above-mentioned problems can be solved by using specific compounds in combination as raw material compounds for obtaining a polyester resin, thereby completing the present invention.

Specifically, the present invention provides a polyester resin composition for an electrophotographic toner, which contains a polyester resin (A) which is obtained by reacting a monobasic acid (a1), a polybasic acid (a2), a polyhydric alcohol (a3), a monoepoxy compound (a4), and a polyepoxy compound (a5) having four or more epoxy groups.

Further, the present invention provides an electrophotographic toner, which contains the above-mentioned polyester resin composition for an electrophotographic toner.

### Advantageous Effects of Invention

The electrophotographic toner obtained using the composition of the present invention has excellent balance between the fixing property at lower temperatures, the resistance to offset, the electrostatic property, and the electrostatic stability, and can be advantageously used in applications in which the toner must meet the requirements at a higher level.

### DESCRIPTION OF EMBODIMENTS

The polyester resin (A) used in the present invention is obtained by reacting a monobasic acid (a1), a polybasic acid (a2), a polyhydric alcohol (a3), a monoepoxy compound (a4), and a polyepoxy compound (a5) having four or more epoxy groups.

By using the monobasic acid (a1) in combination, the range of the molecular weight distribution is broadened, or the crosslinking density can be further increased (a gel component can be formed while suppressing an increase of the melt viscosity) by blocking the end of the multifunctional epoxy compound as a crosslinking agent or the end hydroxyl group of the polyester with the monobasic acid (a1), thus making it easy to obtain a polyester resin containing a gel component (component insoluble in tetrahydrofuran). As a result, an electrophotographic toner having a fixing property at temperatures lower than those conventionally employed, a resistance to offset at high temperatures, and excellent electrostatic property can be obtained.

With respect to the monobasic acid (a1) used in the present invention, there is no particular limitation, and examples thereof include benzoic acid, p-substituted benzoic acid, o-substituted benzoic acid, acetic acid, propionic acid, and butyric acid. From the viewpoint of further increasing the molecular weight to obtain a toner having excellent low-temperature fixing property and of achieving more excellent pulverization property and the viewpoint of further improving the electrostatic property and electrostatic stability of the obtained toner, the monobasic acid (a1) is preferably an aromatic monocarboxylic acid, especially preferably benzoic acid or p-substituted benzoic acid, most preferably para-tertiary-butylbenzoic acid.

With respect to the polybasic acid (a2) used in the present invention, a saturated polybasic acid or an unsaturated polybasic acid, an acid anhydride thereof, or a lower alkyl ester thereof can be used.

Examples of the saturated polybasic acids, saturated polybasic acids, and lower alkyl esters of saturated polybasic acids include dibasic acids, such as adipic acid, sebacic acid, orthophthalic acid, phthalic anhydride, isophthalic acid, terephthalic acid, succinic acid, succinic anhydride, an ester of an alkyl having 8 to 18 carbon atoms of succinic acid, an alkyl ester of succinic anhydride, an alkenyl succinate, and an alkenyl ester of succinic anhydride; and polybasic acids, such as trimellitic acid, trimellitic anhydride, cyanuric acid, pyromellitic acid, and pyromellitic anhydride. Examples of the unsaturated polybasic acids include maleic acid, maleic anhydride, and fumaric acid, and these may be used individually or in combination.

With respect to the polybasic acid (a2), in view of obtaining a toner having excellent offset resistance and excellent low-temperature fixing property, preferred is a polybasic acid containing one or more compounds selected from the group consisting of dibasic acids, anhydrides thereof, and lower alkyl esters thereof, and, among the one or more compounds selected from the group consisting of dibasic acids, anhydrides thereof, and lower alkyl esters thereof, more preferred are isophthalic acid and terephthalic acid.

Further, the above-mentioned polybasic acid (a2) in which part of or all of the carboxyl groups are an alkenyl ester or an allyl ester can be used.

From the viewpoint of obtaining an electrophotographic toner having more excellent low-temperature fixing property, the ratio of the monobasic acid (a1) and polybasic acid (a2) used, i.e., the (a1)/(a2) ratio is preferably 1/99 to 30/70 (mass ratio), especially preferably 2/98 to 26/74.

As the polyhydric alcohol (a3) used in the present invention, for example, there can be mentioned a dihydric alcohol and a trihydric or polyhydric alcohol.

Examples of the dihydric alcohol include aliphatic diols, such as linear aliphatic diols and alicyclic diols, and aromatic diols. Examples of the linear aliphatic diol include ethylene glycol, diethylene glycol, triethylene glycol, propylene glycol, dipropylene glycol, tripropylene glycol, butanediol, pentanediol, hexanediol, 2-ethyl-4-butylhexanediol, butylethylpropanediol, 2,4-diethyl-3,5-pentadiol, polyethylene glycol, polypropylene glycol, ethylene oxide-propylene oxide random copolymer diol, ethylene oxide-propylene oxide block copolymer diol, ethylene oxide-tetrahydrofuran copolymer diol, and polycaprolactonediol.

Examples of the alicyclic diol include 1,4-cyclohexanedimethanol and hydrogenated bisphenol A.

Examples of the aromatic diol include diols having a bisphenol skeleton. Examples of diol having a bisphenol skeleton include bisphenols, such as bisphenol A and bisphenol F; and alkylene oxide addition products of bisphenol A, such as an ethylene oxide addition product of bisphenol A and a propylene oxide addition product of bisphenol A.

Examples of the trihydric or polyhydric alcohol include glycerol, trimethylolethane, trimethylolpropane, pentaerythritol, dipentaerythritol, and 2-methylpropanetriol.

The polyhydric alcohol (a3) may be used individually or two or more polyhydric alcohols (a3) may be used in combination. A monoalcohol, such as stearyl alcohol, may be used if necessary in such an amount that the effects of the present invention are not impaired.

With respect to the monoepoxy compound (a4) used in the present invention, as preferred examples, there can be mentioned phenyl glycidyl ether, an alkylphenyl glycidyl ether, an alkyl glycidyl ether, an alkyl glycidyl ester, a glycidyl ether of an alkylphenol alkylene oxide addition product, an α-olefin oxide, and a monoepoxyfatty acid alkyl ester.

Examples of the alkyl phenyl glycidyl ether include cresyl glycidyl ether, butyl glycidyl ether, and nonyl glycidyl ether, and examples of the alkyl glycidyl ether include butyl glycidyl ether and 2-ethylhexyl glycidyl ether.

As the alkyl glycidyl ester, there can be mentioned, for example, a compound represented by the following formula (1):

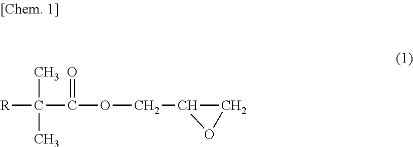

wherein, in formula (1), R is an alkyl group having 1 to 25 carbon atoms, preferably an alkyl group having 10 to 15 carbon atoms.

Further, as the glycidyl ether of an alkylphenol alkylene oxide addition product, there can be mentioned, for example, a glycidyl ether of a compound obtained by adding an alkylene oxide, such as ethylene oxide or propylene oxide, to a lower alkylphenol, such as butylphenol, and specific examples thereof include glycidyl ether of ethylene glycol monophenyl ether, glycidyl ether of polyethylene glycol monophenyl ether, glycidyl ether of propylene glycol monophenyl ether, glycidyl ether of polypropylene glycol monophenyl ether, glycidyl ether of propylene glycol mono (p-t-butyl) phenyl ether, and glycidyl ether of ethylene glycol monononylphenyl ether.

As examples of the α-olefin oxide, there can be mentioned compounds obtained by oxidizing an olefin, such as Alpha-olefin oxide-168 (product manufactured by Adeka Argus Chemical Co., Ltd.), and Alpha-olefin oxide-124 (product manufactured by Adeka Argus Chemical Co., Ltd.).

As examples of the monoepoxyfatty acid alkyl ester, there can be mentioned compounds obtained by epoxidizing the unsaturated group of an alcohol ester of an unsaturated fatty acid, such as a butyl ester of epoxidized oleic acid, a compound represented by the following structural formula (2):

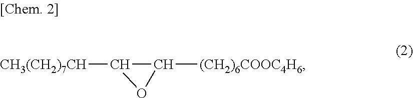

and an octyl ester of epoxidized oleic acid. These monoepoxy compounds may be used individually or two or more thereof may be used in combination.

With respect to the monoepoxy compound (a4) used in the present invention, in view of excellent affinity of the obtained polyester resin (A) with a wax, more preferred is a monoepoxy compound represented by the above formula (1).

The polyepoxy compound (a5) having four or more epoxy groups used in the present invention is used mainly for the purpose of increasing the crosslinking density in the polyester resin, and examples of such polyepoxy compounds include a novolak epoxy resin, a dicyclopentadiene epoxy resin, a bisphenol A novolak epoxy resin, a polymer or copolymer of a vinyl compound having an epoxy group, an epoxidized resorcinol-acetone condensation product, and a partially epoxidized polybutadiene, and these may be used individually or two or more thereof may be used in combination.

With respect to the polyepoxy compound (a5) having four or more epoxy groups used in the present invention, in view of obtaining an electrophotographic toner having excellent fixing property at lower temperatures, excellent resistance to offset at high temperatures, excellent charge amount, and excellent electrostatic stability, preferred are novolak epoxy resins. Among the novolak epoxy resins, preferred are one or more novolak epoxy resins selected from the group consisting of, for example, a cresol novolak epoxy resin, a phenolic novolak epoxy resin, a bisphenol A novolak epoxy resin, a bisphenol A alkylene oxide addition product-type novolak epoxy resin, a bisphenol F alkylene oxide addition product-type novolak epoxy resin, a naphthalene novolak epoxy resin, and a dicyclopentadiene novolak epoxy resin. Further, a cresol novolak epoxy resin, a bisphenol A novolak epoxy resin, and a phenolic novolak epoxy resin are more desirable.

Further, the polyepoxy compound (a5) having four or more epoxy groups used in the present invention is preferably a novolak epoxy resin having 4 to 15 epoxy groups.

In view of obtaining an electrophotographic toner having excellent fixing property at lower temperatures, excellent resistance to offset at high temperatures, and excellent electrostatic stability, the sum of the amounts of the monoepoxy compound (a4) and the polyepoxy compound (a5) having four or more epoxy groups is preferably in the range of from 0.5 to 10% by mass, more preferably in the range of from 0.6 to 9% by mass, based on the total mass of the all charged raw materials.

With respect to the polyester resin (A) used in the present invention, in view of obtaining an electrophotographic toner having excellent fixing property at lower temperatures, excellent resistance to offset at high temperatures, excellent charge amount, and excellent electrostatic stability, preferred is a polyester resin obtained using 0.5 to 8 parts by mass of the monobasic acid (a1), 25 to 75 parts by mass of the polybasic acid (a2), 20 to 75 parts by mass of the polyhydric alcohol (a3), 0.1 to 2 parts by mass of the monoepoxy compound (a4), and 0.4 to 8 parts by mass of the polyepoxy compound (a5) having four or more epoxy groups, relative to the total mass of (a1) to (a5), and more preferred is a polyester resin obtained using 1 to 7 parts by mass of the monobasic acid (a1), 30 to 70 parts by mass of the polybasic acid (a2), 20 to 65 parts by mass of the polyhydric alcohol (a3), 0.1 to 2 parts by mass of the monoepoxy compound (a4), and 0.5 to 7 parts by mass of the polyepoxy compound (a5) having four or more epoxy groups, relative to the total mass of (a1) to (a5).

Further, in the polyester resin (A) used in the present invention, from the viewpoint of a balance between the fixing property at lower temperatures and the resistance to offset at high temperatures, the ratio of the mass of the monobasic acid (a1) to the total mass of the monoepoxy compound (a4) and the polyepoxy compound (a5) having four or more epoxy groups {a1/[a4+a5]} is preferably in the range of from 3/97 to 70/30.

The polyester resin (A) used in the present invention is produced arbitrarily by a known polycondensation reaction method. For example, the production may be conducted by any method of a transesterification reaction, a dehydration reaction under atmospheric pressure, a dehydration reaction under a reduced pressure or in a vacuum, a solution polycondensation method, a solid phase polycondensation method or the like using a lower alkyl ester, such as methyl dicarboxylate, in the presence of an esterification catalyst (such as a tin compound, a titanium compound, or a zirconium compound) or in the presence of a transesterification catalyst (such as a lead compound, a tin compound, a zinc compound, or a titanium compound). Tracing of the polyester-forming reaction in this instance can be made by measuring an acid value, a hydroxyl value, a viscosity, or a softening point.

With respect to the apparatus used in this reaction, for example, a batch production apparatus, such as a reaction vessel equipped with a nitrogen introducing inlet, a thermometer, a stirring apparatus, a distillation column, and the like, can be preferably used, and further, an extruder having a vent, a continuous reaction apparatus, a kneader, and the like can be used. During the above-mentioned dehydration condensation, if necessary, the reaction system can be under a reduced pressure to promote the esterification reaction.

Particularly, from the viewpoint of efficiently obtaining a polyester resin having excellent balance between the low-temperature fixing property, the resistance to offset at high temperatures, and the electrostatic property and having the below-mentioned gel content and viscoelastic property, preferred is a method (so-called batch charging method) comprising dissolving and mixing the monobasic acid (a1), polybasic acid (a2), polyhydric alcohol (a3), monoepoxy compound (a4), and polyepoxy compound (a5) having four or more epoxy groups, which are raw materials, and then adding an esterification catalyst to the resultant mixture and increasing the temperature of the mixture to perform a reaction.

When producing the polyester resin (A) used in the present invention, polycondensation is preferably conducted in the presence of a titanium compound having a phosphorus compound covalent-bonded thereto and/or a titanium compound having a phosphorus compound coordinate-bonded thereto as a titanium compound because the produced polyester resin (A) is a transparent polyester resin having coloring suppressed.

The titanium compound includes a titanium compound having a phosphorus compound covalent-bonded thereto and a titanium compound having a phosphorus compound coordinate-bonded thereto. As a titanium compound having a phosphorus compound covalent-bonded thereto, for example, there can be mentioned a titanium compound having a structure in which a phosphorus compound is bonded to the titanium compound through an ether linkage of the phosphorus compound. As a titanium compound having a phosphorus compound coordinate-bonded thereto, for example, there can be mentioned a titanium compound having a structure in which a phosphorus compound is bonded to the titanium compound through an unshared electron pair of the phosphorus compound. Examples of such compounds include phosphate titanium compounds, phosphite titanium compounds, phosphonic acid titanium compounds, phosphonous acid titanium compounds, phosphinic acid titanium compounds, phosphinous acid titanium compounds, phosphine oxide acid titanium compounds, and phosphine titanium compounds.

Examples of the phosphate titanium compounds include monophosphate titanium compounds, bisphosphate titanium compounds, and trisphosphate titanium compounds. Examples of the monophosphate titanium compounds include triisopropoxytitanium-dioctyl phosphate, triisopropoxytitanium-dioctyl pyrophosphate, tributoxytitanium-dioctyl phosphate, tributoxytitanium-dioctyl pyrophosphate, tri-2-ethylhexyloxytitanium-dioctyl phosphate, tri-2-ethylhexyloxytitanium-dioctyl pyrophosphate, tristearoxytitanium-dioctyl phosphate, and tristearoxytitanium-dioctyl pyrophosphate.

Examples of the bisphosphate titanium compounds include diisopropoxytitanium-bisdioctyl phosphate, diisopropoxytitanium-bisdioctyl pyrophosphate, dibutoxytitanium-bisdioctyl phosphate, dibutoxytitanium-bisdioctyl pyrophosphate, di-2-ethylhexyloxytitanium-bisdioctyl phosphate, di-2-ethylhexyloxytitanium-bisdioctyl pyrophosphate, distearoxytitanium-bisdioctyl phosphate, distearoxytitanium-bisdioctyl pyrophosphate, bisdioctyl phosphate ethylene glycolatotitanium, bisdioctyl pyrophosphate-ethylene glycolatotitanium, titanium-bisdioctyl pyrophosphate oxyacetate, and titanium-bisdioctyl phosphate oxyacetate.

Examples of the trisphosphate titanium compounds include isopropoxytitanium-trisoctyl phosphate, isopropoxytitanium-trisdioctyl pyrophosphate, butoxytitanium-trisdioctyl phosphate, butoxytitanium-trisdioctyl pyrophosphate, 2-ethylhexyloxytitanium-trisdioctyl phosphate, 2-ethylhexyloxytitanium-trisdioctyl pyrophosphate, stearoxytitanium-trisdioctyl phosphate, and stearoxytitanium-trisdioctyl pyrophosphate.

Examples of the phosphite titanium compounds include monophosphite titanium compounds, bisphosphite titanium compounds, and trisphosphite titanium compounds. Examples of the monophosphite titanium compounds include triisopropoxytitanium-dioctyl phosphite, tributoxytitanium-dioctyl phosphite, tri-2-ethylhexyloxytitanium-dioctyl phosphite, and tristearoxytitanium-dioctyl phosphite.

Examples of the bisphosphite titanium compounds include diisopropoxytitanium-bisdioctyl phosphite, dibutoxytitanium-bisdioctyl phosphite, di-2-ethylhexyloxytitanium-bisdioctyl phosphite, distearoxytitanium-bisdioctyl phosphite, bisdioctyl phosphite ethylene glycolatotitanium, titanium-bisdioctyl phosphite oxyacetate, and tetraisopropoxytitanium-bisdioctyl phosphite.

Examples of the trisphosphite titanium compounds include isopropoxytitanium-trisoctyl phosphite, butoxytitanium-trisdioctyl phosphite, 2-ethylhexyloxytitanium-trisdioctyl phosphite, stearoxytitanium-trisdioctyl phosphite, and isopropoxytitanium-trisdioctyl phosphite.

Examples of the phosphonic acid titanium compounds include isopropoxytitanium-trisdioctylphosphonic acid, bisdioctylphosphonic acid ethylene glycolatotitanium, and isopropoxytitanium-bisdioctylphosphonic acid.

Examples of the phosphonous acid titanium compounds include isopropoxytitanium-trisdioctylphosphonous acid, bisdioctylphosphonous acid ethylene glycolatotitanium, and isopropoxytitanium-bisdioctylphosphonous acid.

Examples of the phosphinic acid titanium compounds include isopropoxytitanium-trisoctylphosphinic acid, bisoctylphosphinic acid ethylene glycolatotitanium, and isopropoxytitanium-bisoctylphosphinic acid.

Examples of the phosphinous acid titanium compounds include isopropoxytitanium-trisoctylphosphinous acid, bisoctylphosphinous acid ethylene glycolatotitanium, and isopropoxytitanium-bisoctylphosphinous acid.

Examples of the phosphine oxide acid titanium compounds include isopropoxytitanium-trisdioctylphosphine oxide, isopropoxytitanium-trisdioctylphosphine oxide, bisdioctylphosphine oxide ethylene glycolatotitanium, bisdioctylphosphine oxide ethylene glycolatotitanium, isopropoxytitanium-bisdioctylphosphine oxide, and isopropoxytitanium-bisdioctylphosphine oxide.

Examples of the phosphinic acid titanium compounds include isopropoxytitanium-trisdioctylphosphine, isopropoxytitanium-trisdioctylphosphonous, bisdioctylphosphine ethylene glycolatotitanium, bisdioctylphosphine ethylene glycolatotitanium, isopropoxytitanium-bisdioctylphosphine, and isopropoxytitanium-bisdioctylphosphine.

With respect to the titanium compound, in view of forming a highly transparent polyester resin having coloring further suppressed so as to obtain an electrophotographic toner exhibiting excellent gloss, preferred is a polyester resin obtained using a phosphate titanium compound or a phosphite titanium compound, more preferred is a polyester resin obtained using a bisphosphate titanium compound or a bisphosphite titanium compound, and further preferred is a polyester resin obtained using a pyrophosphate titanium compound.

Further, with respect to the polyester resin (A) used in the present invention, in view of obtaining an electrophotographic toner that produces a printed material having excellent gloss, preferred is a polyester resin obtained using a titanium compound having an alkylene oxide chain as a titanium compound having a phosphorus compound covalent-bonded thereto and/or a titanium compound having a phosphorus compound coordinate-bonded thereto. The alkylene oxide chain is preferably an alkylene oxide chain having 2 to 22 carbon atoms.

Especially, the titanium compound is more preferably titanium-bisdioctyl pyrophosphate oxyacetate or diisopropoxytitanium-bisdioctyl phosphate.

With respect to the amount of the titanium compound having a phosphorus compound covalent-bonded thereto and/or the titanium compound having a phosphorus compound coordinate-bonded thereto, in view of the excellent reaction efficiency and suppressed coloring of the polyester resin obtained, the titanium compound is preferably used in an amount of 1 to 5,000 ppm, more preferably used in an amount of 10 to 1,000 ppm, based on the total mass of the raw materials constituting the polyester resin (A).

With respect to the polyester resin used in the present invention, in view of obtaining an electrophotographic toner having a further excellent resistance to offset at high temperatures, the mass percentage of a component insoluble in tetrahydrofuran (gel content) at 25° C. is preferably in the range of from 10 to 70% by mass, especially preferably in the range of from 20 to 60% by mass.

Further, from the viewpoint of a balance between the low-temperature fixing property and the resistance to offset at high temperatures of the obtained electrophotographic toner, in the results of viscoelasticity measurement with respect to the polyester resin (A), a difference between a tan δ value at 250° C. and a tan δ value at 100° C. [tan δ 250−tan δ 100] is preferably 1.00 or less, further preferably 0.60 or less. The tan δ value used here is determined from [loss modulus G″/storage modulus G′] in a viscoelasticity measurement, namely, represented by the following formulae (1) and (2).

tan δ 250=[loss modulus G″ at 250° C.]/[storage modulus G′ at 250° C.] (1)

tan δ 100=[loss modulus G″ at 100° C.]/[storage modulus G′ at 100° C.] (2)

The storage modulus and loss modulus are values measured by the method shown below.

Apparatus for measurement: HAAKE RS600

Conditions for measurement: Strain control mode

Temperature elevation rate: 4° C./min; Frequency: 1 Hz; Strain: 5%; Measurement temperature: 80 to 250° C.

Further, the polyester resin (A) preferably has a glass transition temperature (Tg) in the range of from 45 to 90° C., more preferably in the range of from 55 to 85° C. In view of obtaining a further excellent resistance to offset at high temperatures, preferred is a polyester resin having a softening point (T1/2) of 90 to 210° C., and more preferred is a polyester resin having a softening point of 100 to 180° C.

Accordingly, preferred is a polyester resin having a glass transition temperature (Tg) of 50 to 90° C. and having a softening point (T1/2) of 90 to 210° C., and more preferred is a polyester resin having a glass transition temperature (Tg) of 55 to 85° C. and having a softening point (T1/2) of 100 to 180° C.

The glass transition temperature is a value measured under the conditions shown below.

Apparatus for measurement: DSC 220C, manufactured by Seiko Instruments Inc.

Conditions for measurement: 10° C./min; Sample: about 10 mg of a sample is placed in an aluminum container and a cover is put on the container.

Method for measurement: DSC (differential scanning calorimeter analysis) method

The softening point (T1/2) was measured under the conditions shown below.

Apparatus for measurement: CFT-500D, manufactured by Shimadzu Corporation

Conditions for measurement: Temperature elevation rate: 6° C./min; Nozzle: 1.0 mmΦ×10 mm; Load: 10 kgf; Amount of a sample: 1.5 g

The softening point (T1/2) used here means a temperature at which a plunger (piston) in an elevated flow tester (CFT-500D, manufactured by Shimadzu Corporation) has reached an intermediate point during the process of from the start of flow to the end of flow.

The resin composition for an electrophotographic toner of the present invention contains the above-mentioned polyester resin and, if necessary, a release agent, a colorant, an electrostatic control agent, or the like can be added to the resin composition.

Examples of the release agents include various types of waxes. For example, a natural wax, such as a montan wax, a carnauba wax, a candelilla wax, or a rice wax, or a synthetic wax, such as a polypropylene wax or a polyethylene wax, can be used.

Particularly, in the heated roller fixing application, for the purpose of preventing the toner from causing a problem of deposition on a heated roller (offset), a release agent can be used. Examples of such release agents include various types of waxes. For example, a natural wax, such as a montan wax, a carnauba wax, a candelilla wax, or a rice wax; or a synthetic wax, such as a polypropylene wax or a polyethylene wax, can be used. Preferred examples of waxes include VISCOL 660P and VISCOL 550P (manufactured by Sanyo Chemical Industries, Ltd.), which are synthetic polypropylene waxes.

With respect to the ratio of the mass of the release agent in the resin composition for an electrophotographic toner of the present invention, there is no particular limitation, and, generally, the amount of the release agent is 0.3 to 15 parts by mass, preferably 1 to 5 parts by mass, relative to 100 parts by mass of the resin composition for a toner.

Examples of the colorants include various types of non-magnetic organic pigments and inorganic pigments, such as carbon black, aniline blue, charcoal blue, chrome yellow, ultramarine blue, phthalocyanine blue, lamp black, rose red oxide, quinacridone red, and Watchung red, and one or two or more thereof can be used individually or in combination.

With respect to the ratio of the mass of the colorant in the resin composition for an electrophotographic toner of the present invention, there is no particular limitation, and, generally, the amount of the colorant is 1 to 60 parts by mass, preferably 3 to 30 parts by mass, relative to 100 parts by mass of the resin composition for a toner.

Examples of the electrostatic control agents include electrostatic control agents, such as a nigrosine dye, a quaternary ammonium salt, a trimethylethane dye, copper phthalocyanine, perylene, quinacridone, an azo pigment, and a heavy metal-containing acid dye, e.g., a metal complex salt azo dye, and one or two or more thereof can be used individually or in combination.

With respect to the ratio of the mass of the electrostatic control agent in the resin composition for an electrophotographic toner of the present invention, there is no particular limitation, and the amount of the electrostatic control agent is preferably 0.5 to 3 parts by mass, relative to 100 parts by mass of the resin composition for a toner.

Further, in the resin composition for an electrophotographic toner of the present invention, various resins, for example, a styrene resin, a styrene-acryl copolymer resin, an epoxy resin, a polyester resin other than those mentioned above, a silicone resin, or a polyurethane resin can be used in an appropriate amount such that the effects of the present invention are not impaired. The amount of the resin incorporated is generally about 1 to 30 parts by mass, relative to 100 parts by mass of the polyester resin.

An electrophotographic toner, which is obtained using the resin composition for an electrophotographic toner of the present invention, can be obtained according to an arbitrary method for production. For example, the electrophotographic toner can be obtained by a method in which the polyester resin and a colorant are melt-kneaded at a temperature of the melting point of the polyester resin or higher, followed by pulverization and classification. The electrophotographic toner may be produce by a method other than the above method.

When obtaining the electrophotographic toner of the present invention, various types of auxiliaries, such as a fluidity-improving agent, can be further added in an arbitrary step for the production. The fluidity-improving agent is effective when it is deposited on the surface of the electrophotographic toner.

The toner powder obtained in the present invention as such can be used as a toner, and, when silica is added to the toner powder, the powder fluidity can be further improved and this is advantageous from a practical point of view.

There are silica having a relatively large average particle diameter and silica having a relatively small average particle diameter, and these may be used individually or in combination. In view of the obtained charge amount satisfactory such that a problem of a damage of the photosensitive drum or deterioration of the environmental properties of the toner is not caused, a practically advantageous amount of the silica added is 0.1 to 5.0 parts by mass, relative to 100 parts by mass of the toner particles.

The electrophotographic toner of the present invention has excellent electrostatic stability. For example, the electrophotographic toner of the present invention has a charge amount of −30 μC/g to −70 μC/g.

In the present invention, a charge amount was measured under the conditions shown below.

Apparatus for measurement: 210HS-2A Blow-off charge amount measurement apparatus, manufactured by Trek Japan Co., Ltd.

Conditions for measurement: 25° C./RH 60%

Method for measurement: A mixture of 1.5 g of a resin and 48.5 g of Ferrite carrier MF-100 (manufactured by Nippon Teppun Co., Ltd.) was mixed in a 50 ml plastic container using a mixer for 1 minute, for 10 minutes, for 30 minutes, and for 60 minutes, and a charge amount was measured by means of a charge amount measurement apparatus.

### EXAMPLES

Hereinbelow, the present invention will be described in more detail with reference to the following Synthesis Examples, Examples, and Comparative Examples. In the following Examples, “part (s)” and “%” are given by mass unless otherwise specified.

### Synthesis Example 1

### Synthesis of Polyester Resin (A-1)

512 g of ethylene glycol, 809 g of neopentyl glycol, 4 g of glycidyl neodecanoate (average of the number of epoxy groups per molecule: 1), and 60 g of a cresol novolak epoxy resin (average of the number of epoxy groups per molecule: 7.6) were placed in a 5-liter four-neck flask, and heated and dissolved and then, 2, 478 g of terephthalic acid, 77 g of adipic acid, and 60 g of para-tertiary-butylbenzoic acid were added to the resultant mixture, and 2 g of diisopropoxytitanium-bisdioctyl phosphate was added thereto and the temperature of the mixture under a nitrogen gas flow was gradually increased to perform a reaction at 250° C. for 7 hours. After confirming that the inside of the system was clear, a reaction was further conducted under a reduced pressure for 5 hours to thereby obtain a polyester resin (A-1) having an acid value of 10, a softening point (T1/2) of 149° C., a glass transition point of 58° C., and a gel content of 41%. The acid value was measured by a titration method, and the glass transition point (Tg), softening point (T1/2), and viscoelastic property values were measured by the methods described above.

### Synthesis Examples 2 and 3

### Synthesis of Polyester Resin

Polyester resins (A2 and A3) were obtained in the same manner as in Synthesis Example 1 except that the raw materials used in Synthesis Example 1 were changed to the raw materials charged of the types and amounts shown in Table 1.

### Synthesis Examples 4 to 8

### Synthesis of Polyester Resin (A′) for Comparison

Polyester resins for comparison (A′1 to A′5) were obtained in the same manner as in Synthesis Example 1 except that the raw materials used in Synthesis Example 1 were changed to the raw materials charged of the types and amounts shown in Table 1.

TABLE 1

| | | Synthesis | Synthesis | Synthesis | Synthesis | Synthesis | Synthesis | Synthesis | Synthesis |
|---|---|---|---|---|---|---|---|---|---|
| | | Example 1 | Example 2 | Example 3 | Example 4 | Example 5 | Example 6 | Example 7 | Example 8 |
| | | A-1 | A-2 | A-3 | A′-1 | A′-2 | A′-3 | A′-4 | A′-5 |
| Monobasic acid (a1) | p-t-Butylbenzoic acid | 60 | 40 | 231 | | | | | |
| Polybasic acid (a2) | Terephthalic acid | 2555 | 1650 | 973 | 2552 | 1377 | 1680 | 1189 | 1364 |
| | Adipic acid | | | | 78 | 65 | | | |
| Polyhydric alcohol | Ethylene glycol | 512 | 346 | 84 | 509 | 909 | 268 | | 400 |
| (a3) | Neopentyl glycol | 809 | | | 804 | | | | |
| | Bisphenol A ethylene oxide | | 706 | 666 | | 599 | 748 | | 626 |
| | 2-mol addition product | | | | | | | | |
| | Bisphenol A propylene oxide | | 1178 | 1802 | | 1000 | 1248 | 2720 | 1010 |
| | 2-mol addition product | | | | | | | | |
| Monoepoxy | Glycidyl neodecanoate | 4 | 4 | 4 | 4 | 3 | 4 | 24 | 200 |
| (a4) | (epoxy group number = 1) | | | | | | | | |
| Polyepoxy | Bisphenol F epoxy resin | | | | | | | | 200 |
| (a5) | (epoxy group number = 2) | | | | | | | | |
| | Cresol novolak epoxy resin | | | 240 | 53 | 44 | 52 | | |
| | (epoxy group number = 4) | | | | | | | | |
| | Cresol novolak epoxy resin | 60 | 76 | | | 3 | | 67 | 200 |
| | (epoxy group number = 7.6) | | | | | | | | |
| Sum of raw materials charged [(a1) + (a2) + | | 4000 | 4000 | 4000 | 4000 | 4000 | 4000 | 4000 | 4000 |
| (a3) + (a4) + (a5)] | | | | | | | | | |
| Mass ratio of monobasic acid to | | 2/98 | 2/98 | 19/81 | 0/100 | 0/100 | 0/100 | 0/100 | 0/100 |
| polybasic acid [(a1)/(a2)] | | | | | | | | | |
| Mass percentage of sum of monoepoxy and | | 1.6 | 2.0 | 0.1 | 0.1 | 0.2 | 0.1 | 2.3 | 15.0 |
| polyepoxy {[(a4) + (a5)]/[(a1) + (a2) + | | | | | | | | | |
| (a3) + (a4) + (a5)]} | | | | | | | | | |
| Mass ratio of monobasic acid to epoxy | | 48/52 | 33/67 | 49/51 | 0/100 | 0/100 | 0/100 | 0/100 | 0/100 |
| {(a1)/[(a4) + (a5)]} | | | | | | | | | |
| Physical | AN (mg KOH/g) | 10 | 11 | 11 | 10 | 11 | 10 | 6 | 10 |
| property | T½ (° C.) | 149 | 148 | 120 | 152 | 147 | 121 | 155 | 133 |
| value | Tg (° C.) | 60 | 64 | 49 | 61 | 62 | 53 | 67 | 65 |
| | Gel content (wt %) | 41 | 30 | 32 | 0.8 | 0.2 | 0.2 | 0.7 | 0.3 |
| | Viscoelastic property [tanδ | 0.48 | −1.43 | −1.40 | 4.11 | 1.15 | 1.69 | 6.74 | 7.25 |
| | 250-tanδ 100] | | | | | | | | |

### Example 1

90 Parts of the polyester resin (A-1), 5 parts of Carbon black MA-11 (manufactured by Mitsubishi Chemical Corporation), part of BONTRON S34 (electrostatic control agent, manufactured by Orient Chemical Industries Co., Ltd.), and 4 parts of a carnauba wax were mixed by means of a Henschel mixer to thereby obtain a polyester resin composition for an electrophotographic toner of the present invention, and then the resin composition was kneaded by means of a twin-screw kneader to obtain a kneaded mixture. The thus obtained kneaded mixture was pulverized and classified by means of AFG100/ATP50 (jet mill serving also as classifier, manufactured by Hosokawa Micron Corporation). 1 Part of Silica R972 (manufactured by Nippon Aerosil Co., Ltd.) was mixed into the classified toner using a Henschel mixer, followed by sieving, to obtain a mixture. 5 Parts of the obtained mixture and 95 parts of a carrier (silicone resin-coated ferrite carrier) were mixed with stirring to prepare an electrophotographic toner (1). The electrophotographic toner (1) was evaluated in accordance with the methods for evaluation described below. The results of the evaluation are shown in the table below.

Examples 2 and 3 and Comparative Examples 1 to 5 Electrophotographic toners in Examples 2 and 3 and Comparative Examples 1 to 5 were prepared in the same manner as in Example 1 except that, instead of the polyester resin (A-1), the polyester resins obtained in Synthesis Examples 2 to 8 were used, and the prepared toners were evaluated with respect to each of the below-shown items. The results are shown in Table 2.

### <Evaluation of the Low-Temperature Fixing Property>

Solid printing was performed while stepwise changing the temperature set for the heated roll by 5° C. from 120° C. to 140° C. The solid printed portion was subjected to fastness test, and, before and after the test, an image density was measured by a Macbeth densitometer (RD-918). A ratio of the density value after peeled to the value before the test was indicated by %, and the temperature at which the ratio is 80% or more was determined as a fixing start temperature. The lower the fixing start temperature, the more excellent the low-temperature fixing property of the electrophotographic toner. The criteria for the evaluation of low-temperature fixing property are as shown below. The fastness test was performed using a Gakushin-type fastness to ribbing testing machine (load: 200 g; rubbing operation: 5 strokes).

A: The fixing start temperature is less than 120° C.

B: The fixing start temperature is 120° C. or more to less than 125° C.

C: The fixing start temperature is 125° C. or more to less than 130° C.

D: The fixing start temperature is 130° C. or more.

### <Method for Evaluating the Resistance to Offset at High Temperatures>

The temperature set for the heated roll was stepwise changed by 5° C. from 160 to 210° C., and the resistance to offset was indicated by the lowest temperature at which offset of the solid printed portion on the same paper occurred and the offset was able to be visually recognized. The higher the temperature, the more excellent the resistance to offset.

A: The offset start temperature is 230° C. or more.

B: The offset start temperature is 215° C. or more to less than 230° C.

C: The offset start temperature is 190° C. or more to less than 215° C.

D: The offset start temperature is less than 190° C.

With respect to a sample such that the resin itself served as a wax to cause the fixing property to a printing medium to be poor, even when offset did not occur at high temperatures, the evaluation of the sample was rated “D”.

The evaluations of the fixing start temperature and the resistance to offset were performed under the following conditions for heated roller fixing apparatus.

Roll material: upper roll: polytetrafluoroethylene; lower roll: silicone

Upper roll load: 7 Kg/350 mm

Nip width: 4 mm

Paper feed speed: 90 mm/sec

### <Evaluation of the Charge Amount and Electrostatic Stability>

A mixture of 1.5 g of the polyester resin pulverized and classified by AFG100/ATP50 (jet mill serving also as classifier, manufactured by Hosokawa Micron Corporation) and 48.5 g of Ferrite carrier MF-100 (manufactured by Nippon Teppun Co., Ltd.) was mixed in a 50 ml plastic container using a tumbling shaker mixer for 1 minute, 10 minutes, 30 minutes, and 60 minutes, respectively, and the resultant mixtures were measured for charge amounts using 210HS-2A Blow-off charge amount measurement apparatus, manufactured by Trek Japan Co., Ltd. An average of these values was determined as a charge amount. Further, in the charge amounts measured above by a charge amount measurement apparatus after mixed using a tumbling shaker mixer for 10 minutes, for 30 minutes, and for 60 minutes, a difference between the maximum charge amount and the minimum charge amount was determined and this value was used as the result of the evaluation of electrostatic stability. The smaller the difference value, the more excellent the electrostatic stability.

### Criteria for the Evaluation of Charge Amount

A: −50 μC/g or more

B: −45 μC/g or more to less than −50 μC/g

C: −40 μC/g or more to less than −45 μC/g

D: −35 μC/g or more to less than −40 μC/g

E: Less than −35 μc/g

### Criteria for the Evaluation of Electrostatic Stability

A: A difference between the maximum charge amount and the minimum charge amount is less than −3 μC/g.

B: A difference between the maximum charge amount and the minimum charge amount is −3 μC/g or more to less than −6 μC/g.

C: A difference between the maximum charge amount and the minimum charge amount is −6 μC/g or more to less than −9 μC/g.

D: A difference between the maximum charge amount and the minimum charge amount is −9 μC/g or more.

TABLE 2

| | | Low- | Resistance | | |
|---|---|---|---|---|---|
| | | temperature | to offset | | Electro- |
| | | fixing | at high | Charge | static |
| | Resin | property | temperatures | amount | stability |
| Example 1 | A-1 | B | A | B | B |
| Example 2 | A-2 | B | A | B | B |
| Example 3 | A-3 | A | B | B | B |
| Comparative | A′-1 | C | C | C | C |
| Example 1 | | | | | |
| Comparative | A′-2 | C | C | B | B |
| Example 2 | | | | | |
| Comparative | A′-3 | C | D | C | D |
| Example 3 | | | | | |
| Comparative | A′-4 | C | C | C | C |
| Example 4 | | | | | |
| Comparative | A′-5 | C | D | B | B |
| Example 5 | | | | | |

1-11. (canceled)

12. A polyester resin composition for an electrophotographic toner, comprising a polyester resin (A) which is obtained by reacting a monobasic acid (a1), a polybasic acid (a2), a polyhydric alcohol (a3), a monoepoxy compound (a4), and a polyepoxy compound (a5) having four or more epoxy groups.

13. The polyester resin composition for an electrophotographic toner according to claim 12, wherein the polyester resin (A) has a gel content in the range of from 10 to 70% by mass.

14. The polyester resin composition for an electrophotographic toner according to claim 12, wherein, in the results of viscoelasticity measurement with respect to the polyester resin (A), a difference (tan δ 250−tan δ 100) between a tan δ value at 250° C. (tan δ 250) represented by the following formulae (1) and a tan δ value at 100° C. (tan δ 100) represented by the following formula (2) is 1.00 or less:
tan δ 250=[loss modulus G″ at 250° C.]/[storage modulus G′ at 250° C.] (1); and
tan δ 100=[loss modulus G″ at 100° C.]/[storage modulus G′ at 100° C.] (2).

15. The polyester resin composition for an electrophotographic toner according to claim 12, wherein the ratio (a1)/(a2) of the monobasic acid (a1) and polybasic acid (a2) used is 1/99 to 30/70 (mass ratio).

16. The polyester resin composition for an electrophotographic toner according to claim 12, wherein the polyepoxy compound (a5) having four or more epoxy groups is a novolak epoxy resin having 4 to 10 epoxy groups.

17. The polyester resin composition for an electrophotographic toner according to claim 12, wherein the sum of the amounts of the monoepoxy compound (a4) and the polyepoxy compound (a5) having four or more epoxy groups is in the range of from 0.5 to 10% by mass based on the total mass of the all charged raw materials.

18. The polyester resin composition for an electrophotographic toner according to claim 12, wherein the ratio of the mass of the monobasic acid (a1) to the total mass of the monoepoxy compound (a4) and the polyepoxy compound (a5) having four or more epoxy groups {a1/[a4+a5]} is in the range of from 3/97 to 70/30.

19. The polyester resin composition for an electrophotographic toner according to claim 12, wherein the ratio of the mass of the monobasic acid (a1) to the total mass of the monoepoxy compound (a4) and the polyepoxy compound (a5) having four or more epoxy groups {a1/[a4+a5]} is in the range of from 33/67 to 49/51.

20. An electrophotographic toner comprising the polyester resin composition for an electrophotographic toner according to claim 12.

21. An electrophotographic toner comprising the polyester resin composition for an electrophotographic toner according to claim 13.

22. An electrophotographic toner comprising the polyester resin composition for an electrophotographic toner according to claim 14.

23. An electrophotographic toner comprising the polyester resin composition for an electrophotographic toner according to claim 15.

24. An electrophotographic toner comprising the polyester resin composition for an electrophotographic toner according to claim 16.

25. An electrophotographic toner comprising the polyester resin composition for an electrophotographic toner according to claim 17.

26. An electrophotographic toner comprising the polyester resin composition for an electrophotographic toner according to claim 18.

27. An electrophotographic toner comprising the polyester resin composition for an electrophotographic toner according to claim 19.
